(19) United States
(12) Patent Application Publication
(10) Pub. No.: US 2017/0147442 A1
(43) Pub. Date: May 25, 2017

(54) AUTOMATIC ASSIGNMENT OF DUMP

(71) Applicant: EMC Corporation, Hopkinton, MA (US)

(72) Inventors: Huibing Xiao, Beijing (CN); Jian Gao, Beijing (CN); Geng Han, Beijing (CN); Jibing Dong, Beijing (CN); Jamin Jianbin Kang, Beijing (CN); Hongpo Gao, Beijing (CN)

(21) Appl. No.: 15/200,269

(22) Filed: Jul. 1, 2016

(30) Foreign Application Priority Data
Jun. 26, 2015 (CN) 201510364956.4

(51) Int. Cl. G06F 11/14; G06F 17/30

(52) U.S. Cl. CPC G06F 11/1451; G06F 17/3053; G06F 2201/84

(57) ABSTRACT

An apparatus, computer program product and method of automatic assignment of a dump by calculating a stack similarity score between an unassigned dump and each of assigned dumps and determining all the assigned dumps having the stack similarity score greater than a stack similarity score threshold as related assigned dumps; calculating a score of other features of each related assigned dumps in response to the determination of the related assigned dump, wherein the other features includes at least one of a recency, a state, a release number, a version number and a duplication value associated with a dump; calculating a total similarity score according to the stack similarity score and the score of the other features and automatically assigning the unassigned dumps based on the total similarity score; and assigning the dump rapidly and accurately by calculating the stack similarity and the score of the other features of the dumps.

### RELATED APPLICATION

This application claim priority from Chinese Patent Application Number CN201510364956.4, filed on Jun. 26, 2015 at the State Intellectual Property Office, China, titled “METHOD AND APPARATUS OF AUTOMATIC ASSIGNEMNT OF DUMP,” the contents of which is herein incorporated by reference in entirety.

### DISCLAIMER

The Portions of this patent document/disclosure may contain command formats and other computer language listings, all of which are subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Embodiments of the present disclosure generally relate to a computer field.

### BACKGROUND OF THE INVENTION

A crash dump may be a state snapshot when a computer system or a progress crashes. Typically crash dumps preserves fault information or environment information when crash or abnormality occurs in a system, which may be used by concerned persons for troubleshooting analysis. In a large system with many functional component areas, a number of crash dumps may be generated during development, test and deployment. After acquiring a crash dump, it may be generally needed to determine which functional area in the large system was responsible for the dump analysis.

Typically, a crash dump can be classified or assigned to a corresponding functional area according to a cause, reason or signature of a dump. Signature may be stack information or other internal status in a dump. For example, stack information in a crash dump is the most frequently used information, and it may be a most valuable signature to map a generated dump to certain functional areas. However, manual assignment of a crash dump in typically costs a lot of time, and also results in low accuracy of assignment of the dump due to knowledge limitation of an analyst. Moreover, different functional areas may cause dumps with similar or even a same stack. Therefore, classification only depending on information in a dump stack may not be sufficiently accurate.

### SUMMARY OF THE INVENTION

Embodiments of the present disclosure provide a method, a computer program product and an apparatus of automatic assignment of a dump. One embodiment includes a method of automatic assignment of a dump by calculating a stack similarity score between an unassigned dump and each of assigned dumps and determining all the assigned dumps having the stack similarity score greater than a stack similarity score threshold.

### BRIEF DESCRIPTION OF THE DRAWINGS

The features, advantages and other aspects of the embodiments of the present disclosure will become more obvious through the following detailed description with reference to the accompanying figures. Several embodiments of the present disclosure are illustrated exemplarily, rather than restrictively, in the figures:

FIG. 1 illustrates a flow chart of a method 100 of automatic assignment of a dump according to one exemplary embodiment of the present disclosure;

FIG. 2 illustrates a flow chart of a method 200 of automatic assignment of a dump according to another exemplary embodiment of the present disclosure;

FIG. 3 illustrates a block diagram of an apparatus 300 of automatic assignment of a dump according to one exemplary embodiment of the present disclosure; and

FIG. 4 illustrates a block diagram of a system 400 in which a computer device can be implemented according to one exemplary embodiment of the present disclosure therein.

### DETAILED DESCRIPTION

Hereinafter, exemplary embodiments of the present disclosure will be described with reference to the figures. Flow charts and block diagrams show system architectures, functions and operations that may be implemented according to the method and the system of various embodiments of the present disclosure. It should be noted that each block in the flow charts or the block diagrams may represent a module, a program segment, or a portion of code, and the module, the program segment or the portion of code may represent one or more executable instructions for performing the specified logical function in each embodiment. It should also be noted that, in some options, functions labeled in the blocks may be performed in a sequence different from that in the figures. For example, two sequential blocks may be actually performed substantially in parallel, or they may be performed in an opposite sequence, which depends on the involved functions. Similarly, it should be noted that, each block in the flow charts and/or the block diagrams and block combination in the flow charts and/or the block diagrams may be implemented using a dedicated hardware-based system for performing the specified function or operation, or may be implemented using combination of dedicated hardware and computer instructions.

It should also be understood that various terminology used herein is for the purpose of describing particular embodiments only and is not intended to be liming of the disclosure. The term “comprise”, “include” or similar terms used herein should be paraphrased as open terms, i.e., “comprise/include but not limited to”. The term “based on” indicates “based at least on”. The term “one embodiment” means “at least one embodiment”; and “another embodiment” represents “at least another embodiment”. As used herein, the singular forms “a”, “an” and “the” may include the plural forms, unless the context clearly indicates otherwise. It will be further understood that the terms “comprises”, “has” and “including” used herein, specify the presence of stated features, elements, and/or components etc., but do not preclude the presence of one or more other features, elements, components and/ or combinations thereof. For example, the term “multiple” used here indicates “two or more”; the term “and/or” used here may comprise any or all combinations of one or more of the items listed in parallel. Definitions of other terms will be specifically provided in the following description. Furthermore, in the following description, some functions or structures well-known to those skilled in the art will be omitted in order not to obscure embodiments of the disclosure in the unnecessary details.

It should be appreciated that exemplary embodiments illustrated are only provided to assist those skilled in the art in better understanding and further implementing the embodiments of the present disclosure, but not intended to limit the scope of the invention in any manner.

Embodiments of the present disclosure provide a method, a computer program product and an apparatus of automatic assignment of a dump. One embodiment may include a method of automatic assignment of a dump by calculating a stack similarity score between an unassigned dump and each of assigned dumps. A further embodiment may include determining all assigned dumps having a stack similarity score greater than a stack similarity score threshold. The method may further include calculating a score of other features of each in a related assigned dumps in response to determination of the related assigned dumps, wherein other features includes at least one of a recency, a state, a release number, a version number and a duplication value associated with a dump. The method may further include calculating a total similarity score according to a stack similarity score and a score of other features and automatically assigning an unassigned dump based on the total similarity score.

In a further embodiment, the method may further include acquiring information related to a stack from a dump and acquiring information related to other features from the dump, a system log or a system database. In a further embodiment, the method may further include selecting a stack directly resulting in dumping to calculate a stack similarity score, or selecting a plurality of stacks in the stacks to calculate a stack similarity score. In a further embodiment, the method may further include calculating a stack similarity score between an unassigned dump and each in assigned dumps by comparing lines in a stack line by line from top to bottom. In a further embodiment, the method may further include calculating a score of each in the other features respectively and calculating a score of the other features according to a weight of each in the other features.

According to another embodiment, the method may further include calculating a recency score of a dump by comparing timestamp information of a dump. A further embodiment may include calculating a state score of a dump by determining a current state of an assigned dump. A further embodiment may include calculating a release score of a dump by comparing release number information of the dump. A further embodiment may include calculating a version score of a dump by comparing version number information of the dump. A further embodiment may include calculating a duplication value score of a dump by determining a number of copies of an assigned dump.

According to a further embodiment, the method may include sorting all dumps according to a timestamp information, a release number information or a version number information. A further embodiment may include calculating a recency score, a release score or a version score according to a sorting interval between the dumps. According to one embodiment, the method further may include calculating a state score of a dump according to an order of a current state of the dump in all states.

According to another embodiment, the method may include calculating a duplication value score of a dump according to an accumulated number of copies of a particular assigned dump in all assigned dumps. According to a further embodiment, the method may include selecting assignment areas of related assigned dumps having top K total similarity scores as candidate assignment areas and performing statistics on assignment areas of related assigned dumps having top K total similarity scores. In a further embodiment the method may further include selecting an assignment area having a highest statistical result as a final assignment area, wherein K≧3.

According to one embodiment, an apparatus of automatic assignment of a dump may include a stack similarity calculating unit for calculating a stack similarity score between an unassigned dump and each of assigned dumps and determining all assigned dumps having a stack similarity score greater than a stack similarity score threshold as related assigned dumps. In a further embodiment, the apparatus may include other features' score calculating unit for calculating a score of other features of each in related assigned dumps in response to a determination of related assigned dumps. In a further embodiment, the other features may include at least one of a recency, a state, a release number, a version number and a duplication value associated with the dump. In a further embodiment, the apparatus may include a total similarity calculating unit for calculating a total similarity score according to a stack similarity score and a score of other features. In a further embodiment, the apparatus may include a dump automatically assigning unit for automatically assigning an unassigned dump based on the total similarity score.

According to one embodiment, the apparatus may further include an information acquiring unit for acquiring information related to a stack from a dump and acquiring information related to other features from a dump, a system log or a system database. According to another embodiment, a stack similarity calculating unit may be further configured for selecting one stack directly resulting in dumping from a dump to calculate a stack similarity score or selecting a plurality of stacks from a dump to calculate a stack similarity score. According to a further embodiment, a stack similarity calculating unit may be further configured for calculating a stack similarity score between an unassigned dump and each of an assigned dump by comparing lines in a stack line by line from top to bottom.

According to one embodiment, other features' score calculating unit may be further configured for calculating a score of each in other features respectively and calculating a score of other features according to a weight of each in the other features. According to another embodiment, the other features' score calculating unit may be further configured for calculating a recency score of a dump by comparing timestamp information of the dump, calculating a state score of a dump by determining a current state of assigned dump, calculating a release score of a dump by comparing release number information of the dump, calculating a version score of a dump by comparing version number information of the dump; and/or calculating a duplication value score of a dump by determining a number of copies of the assigned dump.

According to a further embodiment, the other features' score calculating unit may be further configured for sorting all dumps according to a timestamp information, a release number information or a version number information. In a further embodiment, the other features' score calculating unit may be further configured for calculating a recency score, the release score or the version score according to the sorting interval between the dumps. According to one embodiment, the other features' score calculating unit may be further configured for calculating a duplication value score of a dump according to an accumulated number of copies of a particular assigned dump in all the assigned dumps.

According to another embodiment, the apparatus of automatic assignment of a dump may be further configured for selecting assignment areas of related assigned dumps having top K total similarity scores as candidate assignment areas. A further embodiment may include performing statistics on related assignment areas of assigned dumps having top K total similarity scores. Yet a further embodiment may include selecting an assignment area having a highest statistical result as a final assignment area, wherein K≧3.

A further embodiment may include a computer readable program instruction embodied therein, the computer readable program instruction, when being performed by a processor, cause a processor to perform the method disclosed above.

The exemplary solution provided in the exemplary embodiments may bring about at least one effect wherein an assignment area of an assigned dump most related to an unassigned dump may be determined based on a historical assigned dump information, such as by calculating stack similarity between an unassigned dump and each of the assigned dumps and a score of other features of assigned dumps, and thus a dump may be automatically assigned rapidly and accurately without specific knowledge.

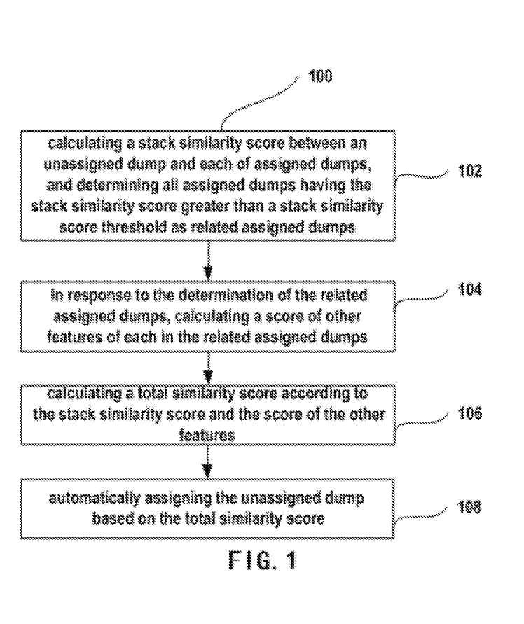

Reference is now made to FIG. 1, which illustrates a flow chart of a method 100 of automatic assignment of a dump according to one exemplary embodiment of the present disclosure. Referring to FIG. 1, step 102 includes calculating a stack similarity score between an unassigned dump and each of assigned dumps and determining all assigned dumps having a stack similarity score greater than a stack similarity score threshold as related assigned dumps. Step 104 includes calculating the a score of other features of each dump in the related assigned dump in response to the determination of the related assigned dumps, wherein the other features comprise at least one of a recency, a state, a release number, a version number and a duplication value associated with the dump. Step 106 includes calculating a total similarity score according to the stack similarity score and the score of the other features. At step 108, the unassigned dumps are automatically assigned based on the total similarity score.

According to one embodiment, information related to a stack may be acquired from a dump, and information related to other features may be acquired from a dump, a system log or a system database. In an example embodiment, key information may be collected from a dump file, and other feature information that cannot be acquired from a dump file may be collected from a real-time system, a reliable log or other resources and so on. In a further embodiment, collection of information related to a dump may be performed in real time, and a database may be built such that information related to the dump may be pre-stored. In a further embodiment, such types of information may, to a great extent, represent association or correlation degree between the dumps, and the information may include but are not limited to stacks in a dump file, a timestamp information of a damp, a state of a dump (i.e., a current processing state of the dump), a release number of a dump, a version number of a dump, and a duplication value of a dump (i.e., repetition time of the dump). In a further embodiment, information may be extracted or processed for the following calculation after the information is collected.

### Stack Similarity Score

In one embodiment, a dump file generally may include one or more stacks. In a further embodiment, stack information may be acquired from a dump file. In a further embodiment, since one stack directly causing dumping may be a direct code path and reason for a dump, only a stack (also named as “panic stack”) directly causing crash dumping may be selected to calculate a stack similarity score. In an alternate embodiment, a plurality of stacks in a dump may be selected to respectively calculate a stack similarity scores, and scores of a plurality of dumps may be weighted and combined to form a total score of a stack similarity. In an optional embodiment, all stacks in a dump may be selected to calculate a stack similarity scores respectively.

According to one embodiment, a stack similarity score between an unassigned dump and each of an assigned dump may be calculated by comparing lines in a stack, line by line from top to bottom. In an example embodiment, an exemplary stack A directly resulting in the dump, which has a 21 lines depth is represented below.

libc.so.6!raise
libc.so.6!abort
libAAA.so!proc_do_abort
libAAA.so!rt_assert_int_take_user_space_panic_action
libBBB.so!rt_assert_fail_hard_assert_with_info
libBBB.so!rt_ux_spl_destroy
libBBB.so!rt_sked_spl_destroy
libBBB.so!p_raw_spl_destroy_nid
CCC.so!p_dsh_sched_spinlock_destroy_nid
DDD.so!p_dsh_spinlock_unconstructed_t::destroy
DDD.so!p_dsh_Sthread_MutexSpl_unconstructed_t::destroy
DDD.so!Sthread_MutexSpl::~Sthread_MutexSpl
DDD.so!SelectStream::~SelectStream
DDD.so!smb_browserInitial::recvDgram
DDD.so!smb_browserInitial::start
DDD.so!Sthread_RootFunction
libBBB.so!csx_p_int_dsh_sched_thread_create_root
libBBB.so!csx_p_int_thread_wrapper
libBBB.so!csx_rt_sked_thread_wrapper
libpthread.so.0!start_thread
libc.so.6!clone

In one embodiment, a stack similarity may be calculated by comparing an exemplary unassigned stack A and a stack of each in an assigned dump line by line. In a further embodiment, a stack similarity or a matching degree between an exemplary stack A and a stack in each assigned dump may be calculated using formula (1

$$S = \frac{d}{D} \qquad ( 1 )$$

wherein S represents a stack similarity score, D represents a total line (depth) of an exemplary stack A, and d represents lines (depth) of maximum match with a stack of an assigned dump. In a further embodiment, when a stack similarity is calculated, comparison may be performed line by line from top to bottom and consecutive matched lines may be determined as the maximum matched lines. In an example embodiment, suppose an assigned dump includes the following stack B.

libc.so.6!raise
libc.so.6!abort
libAAA.so!proc_do_abort
libAAA.so!rt_assert_int_take_user_space_panic_action
libBBB.so!rt_assert_fail_hard_assert_with_info
libEEE.so!myassert
libpthread.so.0!start_thread
libc.so.6!clone

In one embodiment, since the first 5 lines of stack A and the first 5 lines of stack B are identical and are ordered the same from the first line (libc.so.6!raise), the maximum matched lines between stack B and stack A may be 5. In a further embodiment, a stack similarity S between stack A and stack B is 0.24 (namely, S=d/D, wherein d=5 and D=21) using formula (1).

In a further embodiment, if an unassigned dump and a certain assigned dump have same lines and the content of each line in the two dumps is exactly similar, a similarity score between the two dumps is 1; otherwise, the similarity score may be between the range of 0 and 1.

According to another embodiment, a total similarity score of a stack may be calculated by selecting some other stacks (for example, some actively un-waiting stacks during dumping, or some particular stacks that may be useful to describe a stack state). In a further embodiment, a similarity score of each stack in other stacks may be calculated using a foregoing formula for calculating a stack similarity score, another alternative stack similarity score Sa may be given, and then a total similarity score of the stacks can be calculated using formula (2).

S=f(Sa0, Sa1, Sa2, . . . ) (2)

wherein, S represents a total similarity score of stacks, Sa0 represents a similarity score of a stack directly resulting in a crash dump, for example, panic stack, and Sa1˜SaN represent a stack similarity score of other stacks.

In a further embodiment, next, after a stack similarity score is calculated, all assigned dumps having stack similarity scores greater than a stack similarity score threshold may be determined as related assigned dumps. In a further embodiment, a stack similarity may be one of the most important factors for determining whether dumps are similar. In a further embodiment, if a similarity between stacks is low, a similarity between dumps may also be low. In a further embodiment, after calculation of a stack similarity score, dumps having stack similarity score less than or equal to a stack similarity score threshold may be deemed as a low correlation degree and therefore not taken into consideration. In a further embodiment, all assigned dumps having stack similarity scores greater than a stack similarity score threshold may be selected as related assigned dumps for subsequent processing.

One embodiment may include calculating a score (step 104) of other features of each dump in a related assigned dump in response to a determination of related assigned dumps, wherein other features may include at least one of a recency, a state, a release number, a version number and a duplication value associated with a dump. In a further embodiment, though a stack similarity may be a key factor for determining whether dumps are correlated, such automatic assignment method may not be sufficiently accurate if a similarity between the stacks is merely considered. In a further embodiment, besides a stack similarity, a score of other features, for example, a recency of a dump, a state of a dump, a release number of a dump, a version number of a dump and a duplication value of a dump, associated with the dumps may also be calculated. In an alternate embodiment, score(s) of one or more in the other features may be calculated. In a further embodiment, a score of each in other features may be respectively calculated. In an example embodiment, one or more scores among a recency score a state score, a release score, a version score and a duplication value score may be calculated.

### Recency Score

In one embodiment, recency may be defined as time closeness between dumps. In a further embodiment, after a timestamp information of the dumps is acquired, all dumps may be sorted based on a timestamp information of the dumps, and each dump may be assigned a unique T# which may be the order # of a timestamp. In a further embodiment, the T# may be a unique number from 0 to N to mark a dump timeline that may have happened, wherein N is a total number of available dumps. In a further embodiment, a recency score between an assigned dump and an unassigned dump may be calculated through using the formula (3).

R=e^{-(Tu-Ta)}^{²}^{/L}^{²} (3)

wherein, R represents a recency score between an assigned dump and an unassigned dump. In a further embodiment, as a normalization process of an R value has been performed using formula (3), the R value may be between the range of 0-1. In a further embodiment, Tu represents a timestamp order T# of an unassigned dump. In a further embodiment, Ta represents a timestamp order T# of an assigned dump. In a further embodiment, L represents a band width parameter weighted on a most recent dump, indicating that a front L^{th} dumps or those around an L^{th} may be put a key consideration. In a further embodiment, formula (3) is an exemplary calculation method, and as an alternative, a recency score may be determined based on a time interval between dumps.

### State Score

In one embodiment, a dump undergoes a plurality of states from generation to finally being resolved, and states of a dump represent a processing progress of the dump processed by specified regions. In a further embodiment, for instance, a certain dump has following five processing states.
i. When a dump is first generated, its state may be WARNING_ASSIGN.
ii. Then it may be assigned to a corresponding owner, and its state may be IN_PROGESS.
iii. If the owner gets a root cause of a dump, then a state may be set to ROOT_CAUSE_KNOWN.
iv. Then, a corresponding correction processing may be performed, i.e., it enters into a state FIX_IN_PROGRESS.
v. Finally, after a correction processing of a dump is completed, the state may be changed into a corrected state FIXED.
   Hence, the order of the analysis states for a dump is as follows:
   WAITING_ASSIGN(0)→IN_PROGRESS(1)→ROOT_CAUSE_KNOWN(2)→FIX_IN_PROGRESS(3)→FIXED(4)

In one embodiment, as indicated by the above order, if a state of a dump indicates that the dump is relatively new, the dump is scored high. In a further embodiment, generally, newly generated dumps may be more likely to be related to unassigned dumps, and corrected dumps may be less likely to be related to unassigned dumps. In a further embodiment, for a dump having M states, a state score of an assigned dump may be calculated through the formula (4).

$$Sv = 1 - \frac{Os}{N} \qquad ( 4 )$$

wherein, Sv represents a state score of a dump, having a value in the range between 0 and 1, a Os represents an order of a current state of a dump in all the states (for example, IN_PROGRESS state is ordered as 1), and N represents a value selected as normalizing a state score, wherein N≧M. In a further embodiment, for instance, if N is selected as 10, a state score of a dump at a current state IN_PROGRESS may be calculated to be 0.9, while a state score of a dump at a current state FIXED may be 0.6, and this demonstrates that scores of those dumps being processed are much higher. Nonetheless, a state order and formula (4) may only be an exemplary embodiment. In a further embodiment, other state orders may be included and a state score of a dump may be calculated based on a current state of the dump.

### Release Score

In a certain embodiment, considering an engineering organization, many different release numbers may be developed for the same product. In one embodiment, generally, as compared to two dumps tagged with different release numbers, two dumps tagged with a same release number may be more likely to be correlated. In a further embodiment, a release number information may be obtained from a system on which a dump may be generated. In one embodiment, if an unassigned dump and an assigned dump are tagged with a same release number, a release score may be determined to be 1, and if not the same, a release score may be determined to be 0. In another embodiment, if release numbers are sorted according to a time sequence or an order of the releases, release scores of the dumps may be calculated according to a release sorting interval between the dumps using formula (5).

$$Rv = 1 - \frac{\vert s - S \vert}{{s}_{max}} \qquad ( 5 )$$

wherein Rv represents a release score of a dump, Smax represents a maximum serial number of available release numbers, s represents a release serial number of a particular assigned dump, and S represents a release serial number of an unassigned dump. In some embodiments, it may be seen from formula (5) that if release numbers of the dumps are closer, a release score is higher. According to another embodiment, if a dump happens more frequently on a specific release number, this release number may be set to a higher release score.

### Version Score

In a certain embodiment, considering an engineering organization, many different versions may be developed for the same product. In one embodiment, generally, as compared to two dumps tagged with different version numbers, the possibility of two dumps tagged with a same version being correlated may have a high probability. In a further embodiment, a version number information may be generally obtained from a system on which a dump is generated. In one embodiment, if an unassigned dump and an assigned dump are tagged with same version number, a version score may be determined to be 1, and if not the same, a version score may be determined to be 0. In another embodiment, if the versions are sorted according to a time sequence or an order of the version numbers, the version scores of the dumps are calculated according to a version sorting interval between the dumps using the formula (6).

$$V = 1 - \frac{\vert s - S \vert}{{s}_{max}} \qquad ( 6 )$$

wherein V represents a version score of a dump, Smax represents a maximum serial number of available version numbers, s represents a version serial number of a particular assigned dump, and S represents an order serial number of an unassigned dump. In a further embodiment, from formula (6) it may be resolved that if the version numbers of the dumps are closer, a version score may be higher. According to another embodiment, if a dump is happened more frequently on a specific version number, this version number may be set to a higher version score.

### Duplication Value Score

In one embodiment, during analysis or debugging of a historical assigned dump, same dumps may be identified, and dump duplication information may be stored in a database. Alternatively, duplication times of a dump may be recorded during analysis of a dump state. In a further embodiment, conventionally, if a number of dump duplication times is higher, the dump may be more likely to happen and an attention degree and popularity of a dump may grow higher, and thus a possibility of correlation between this dump and an assigned dump may be higher. In a further embodiment, a duplication value score of a dump may be calculated according to an accumulated number of copies of a particular assigned dump in all of the assigned dumps. In an example embodiment, a duplication value score of a dump may be calculated using formula (7).

$$Dv = \frac{Cd}{D} \qquad ( 7 )$$

wherein Dv represents a duplication score of a dump, and its value may be in a range between 0 and 1, Cd represents duplication times of a dump, D represents a maximum duplication number of a dump in all of the dumps. In a further embodiment, if a value associated with D is 0, it may be set to be 1 by default.

In a further embodiment, after a score of each (for example, R, Sv, Rv, V and Dv) in other features may be respectively calculated, a score of other features may be calculated according to a weight of each in other features. According to one embodiment, other features may be set to have a same weight (for example, 1:1), and a score of the other features may be equal to a sum of the respective score of each feature (for example, R, Sv, Rv, V and Dv). According to another embodiment, other features may be set to have different weights, and a comprehensive score of the other features may be calculated according to a respective weight. In an example embodiment, a total score of the other features=a1×R+a2×Sv+a3×Rv+a4×V+a5×Dv, wherein a1-a5 represent weights of respective features.

Continuing to refer to FIG. 1, step 106 includes calculating a total similarity score according to a stack similarity score and a score of the other features. In one embodiment, for instance, considering that a stack similarity is more important, a stack similarity may be set to have a higher weight, while a score of the other features may be assigned a lower weight, and a total similarity score of the dumps may therefore be calculated according to different weights of the stack and the other features.

At step 108, unassigned dumps may be automatically assigned based on the total similarity score. In one embodiment, according to a total similarity score, an assignment area of a most related dump may be selected as a recommended assignment area of an unassigned dump. According to one embodiment, an assigned dump with a highest score may be determined as a most related dump, and then an unassigned dump may be assigned to an assignment area of a most related dump.

According to another embodiment, assignment areas of related assigned dumps with total similarity scores ranked top K may be selected as candidate assignment areas, statistics and voting may be performed for related assignment areas of the top K assigned dumps, and assignment area with a highest statistical result may be selected as a final assignment area, wherein K≧3. In a further embodiment, if one area and another area are counted as having a same number, an area corresponding to a dump having a highest score may be selected as a final assignment area from the dumps corresponding to the two areas. In a further embodiment, for principles of statistical or voting algorithm used in the embodiments, a processing method of a K-neighbor algorithm may be served as a reference.

In an example embodiment, one exemplary classification of a given dump named as safe_dump_spb_FNM00124800443_2014-10-23_15_27_50_29160_safe may be showed as follow, which has an event #680629, and in the example, the top 9 matched assigned dumps many selected for area statistics. In a further embodiment, a statistical result suggests that the most frequently appearing area among the top 9 may be “Platform Core: Platform”, appearing 3 times in total, and thus the automatically assigned area of this given dump of the event #68062 is “Platform Core: Platform”.

TABLE 1
A list of dumps having top 9 total similarity scores

| | Total | | | | | | Duplication | |
|---|---|---|---|---|---|---|---|---|
| Event# | score | Stack | Recency | state | Release | Version | value | area |
| 674427 | 3.726 | 1.000 | 0.826 | 0.900 | 1.000 | 0.000 | 0.000 | Platform Core: Platform |
| 679801 | 3.697 | 1.000 | 0.997 | 0.700 | 1.000 | 0.000 | 0.000 | Platform Core: Platform |
| 678850 | 3.684 | 1.000 | 0.984 | 0.700 | 1.000 | 0.000 | 0.000 | Platform Core: Platform |
| 676635 | 3.624 | 1.000 | 0.924 | 0.700 | 1.000 | 0.000 | 0.000 | EMSD VNX Storage |
| | | | | | | | | Efficiency: Efficiency - |
| | | | | | | | | Dedupe |
| 674991 | 3.553 | 1.000 | 0.853 | 0.700 | 1.000 | 0.000 | 0.000 | Auto AR Triage: Auto AR |
| | | | | | | | | Triage |
| 674988 | 3.553 | 1.000 | 0.853 | 0.700 | 1.000 | 0.000 | 0.000 | Client Framework: REST API |
| | | | | | | | | Framework |
| 668238 | 2.465 | 1.000 | 0.465 | 0.000 | 1.000 | 0.000 | 0.000 | Client Framework: REST API |
| | | | | | | | | Framework |
| 657778 | 2.074 | 1.000 | 0.074 | 1.000 | 0.000 | 0.000 | 0.000 | System Test: Serviceability |
| 657666 | 1.072 | 1.000 | 0.072 | 0.000 | 0.000 | 0.000 | 0.000 | Platform Services: App |
| | | | | | | | | Services-Misc |

In one embodiment, the solution enables rapid and automatic classification of a dump, and accuracy of a dump classification exceeds 60%, while the existing manual dump classification may generally be kept around 50%. In a further embodiment, the solution may be capable of automatically classifying dumps more accurately.

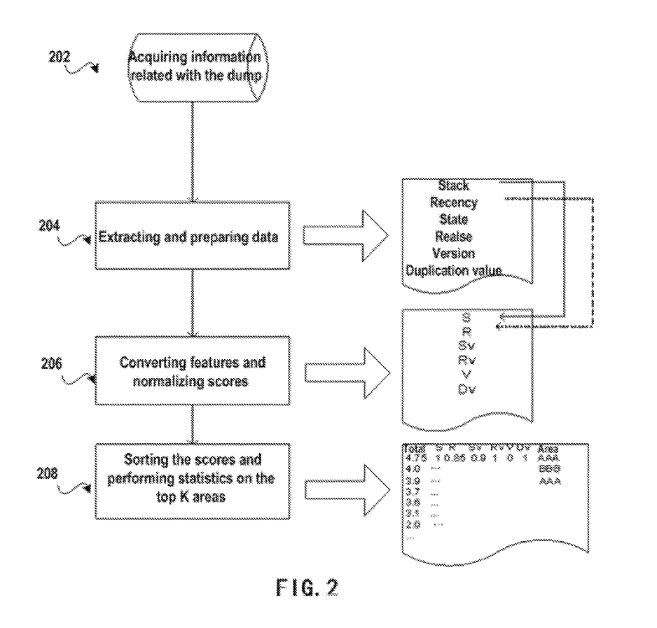

Reference is now made to FIG. 2, which illustrates a flow chart of a method 200 for automatic assignment of a dump according to another exemplary embodiment of the present disclosure. Step 202 includes acquiring information related to the dumps, for example, acquiring at least two of stack information, recency information, state information, release number information, version number information or duplication value information of a dump. Step 204 includes extracting and preparing data from the acquired information, such that the information is converted into a calculable standardized format. Step 206 includes performing feature conversion and normalization and calculating the scores of the corresponding features (for example, at least two of S, R, Sv, Rv, V and Dv described above), and performing normalization on the score of the each feature to enable the score of the each feature to be valued in a numerical range between 0-1. Step 208 includes calculating the total score according to the score of each feature, for example, performing weight calculation according to a weight value associated with each feature or directly adding up the scores of the respective features to obtain the total score. Step 208 further includes sorting the related unassigned dumps according to a total similarity score and selecting areas corresponding to the top K (for example, K=10) dumps for performing statistics. For example, among the top 10, AAA area appears 5 times and BBB area appears 3 times, and thus the most related area is selected, for example, AAA area, for assignment according to the statistical result.

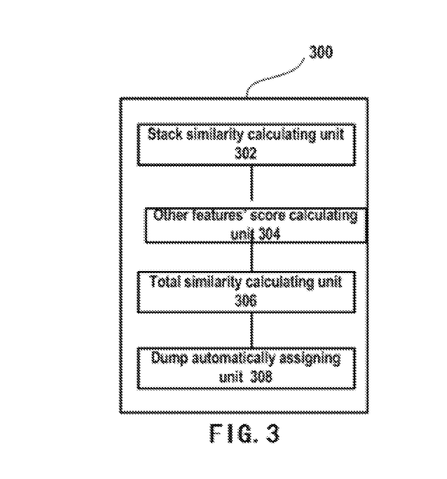

FIG. 3 illustrates a block diagram of an apparatus 300 for automatic assignment of a dump according to one exemplary embodiment of the present disclosure. The apparatus comprises stack similarity calculating unit 302 for calculating a stack similarity score between an unassigned dump and each of assigned dumps and determining all assigned dumps having stack similarity score greater than a stack similarity score threshold as related assigned dumps. Apparatus 300 further comprises other features' score calculating unit 304 for calculating a score of other features of each in the related assigned dumps in response to the determination of the related assigned dumps, and the other features include at least one of a recency, a state, a release number, a version number and a duplication value associated with the dump. Also, apparatus 300 includes a total similarity calculating unit 306 for calculating a total similarity score according to a stack similarity score and a score of the other features and dump automatically assigning unit 308 for automatically assigning the unassigned dumps based on the total similarity score.

It should be appreciated that apparatus 300 may be implemented in various manners. For example, in some embodiments, apparatus 300 may be implemented with hardware, software or a combination of software and hardware, wherein a hardware portion may be implemented with a dedicated logic; a software portion may be stored in the memory and a system is implemented with proper instructions, such as with a microprocessor or dedicated design hardware. Those skilled in the art may understand that the above method and system may be implemented with computer-implementable instructions and/or control codes in the storage device, such as disk, CD or DVD-ROM. Such codes are provided in a ROM programmable memory or data carrier of the optical or digital signal carrier. The device and apparatus of the embodiments of the present disclosure can be implemented with, such as very large scale integrated circuit or gate array, semiconductors such as logic chip and transistors, or hardware circuit of programmable hardware devices such as field-programmable gate array and programmable logic devices, and also be implemented with software implemented by various types of processors and a combination of the above hardware circuit and software.

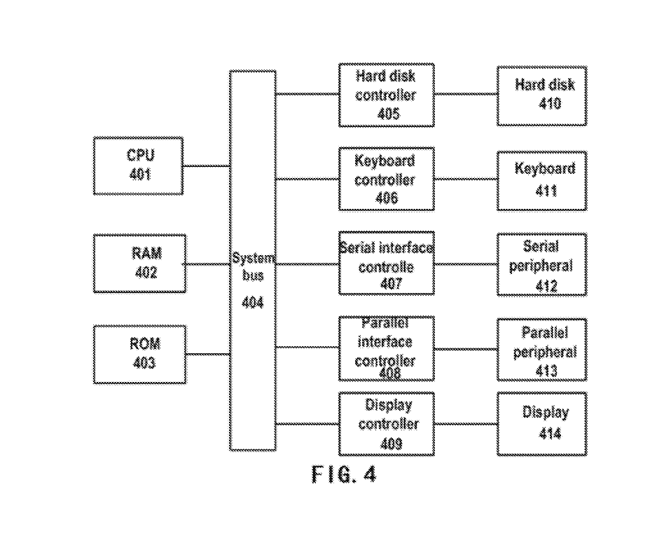

In the following context, a computer device in which the embodiments of the present disclosure can be achieved is described with reference to FIG. 4. FIG. 4 illustrates a block diagram of a system 400 in which the computer device according to an exemplary embodiments of the present disclosure may be implemented.

A computer system shown in FIG. 4 comprises central processing unit (CPU) 401, random access memory (RAM) 402, read only memory (ROM) 403, system bus 404, hard disk controller 405, keyboard controller 406, serial interface controller 407, parallel interface controller 408, display controller 409, hard disk 410, keyboard 411, serial peripheral 412, parallel peripheral 413 and display 414. Among these components, system bus 404 is connected to CPU 401, RAM 402, ROM 403, hard disk controller 405, keyboard controller 406, serial interface controller 407, parallel interface controller 408 and display controller 409. Disk 410 is connected to disk controller 405, keyboard 411 is connected to keyboard controller 406, serial peripheral 412 is connected with serial interface controller 407, parallel peripheral 413 is connected with parallel interface controller 408, and display 414 is connected with display controller 409. It is noteworthy that the structural block diagram illustrated in FIG. 4 is only for the illustration purpose but does not intend to limit the present disclosure. In some cases, some apparatuses therein may be added or removed according to the requirements.

The embodiments of the present disclosure can be stored in the storage device, such as disk 410, and when being loaded into a memory to be operated, CPU 401 performs the automatic assignment method of the dump according to the present disclosure.

It should be noted that though the detailed description given in the previous context provides several devices or sub-devices of the apparatus, the division is only exemplary instead of being obligatory. In fact, the features and functions of the two or more apparatuses described above may be embodied in one apparatus according to the embodiments of the present disclosure. By contrast, the features and functions of one apparatus described above may be divided and embodied in a plurality of apparatuses.

The embodiments disclosed above are only optional embodiments which are not used to limit the embodiments of the present disclosure. For those skilled in the art, the embodiments of the present disclosure may have various modifications and alterations. Any modification, alternative substitution and improvement should be included within the scope of protection of the embodiments of the present disclosure without departing from the spirit or scope of the embodiments of the present disclosure.

Though embodiments of the present disclosure have been described with reference to several specific embodiments, it should be appreciated that the embodiments of the present disclosure are not limited to the specific embodiments of the present disclosure. The embodiments of the present disclosure aim to cover various modifications and equivalent arrangement within the spirit and scope of the appended claims. The scope of the following claims conforms to the broadest explanation and thus includes all the modifications and equivalent structures and functions.

What is claimed is:

1. A method of automatic assignment of a dump, the method comprising:
computing a stack similarity score between an unassigned dump and each assigned dumps, and determining all assigned dumps having the stack similarity score greater than a stack similarity score threshold as related assigned dumps;
in response to the determination of the related assigned dumps, computing a score of other features of each dump in the related assigned dumps, the other features comprising at least one of a recency, a state, a release number, a version number and a duplication value associated with the dump;
calculating a total similarity score according to the stack similarity score and the score of the other features; and
assigning the unassigned dump based on the total similarity score.

2. The method according to claim 1, further comprising:
acquiring information related to a stack from the dump, and acquiring information related to the other features from the dump, a system log or a system database.

3. The method according to claim 1, wherein computing a stack similarity score between an unassigned dump and each of the assigned dumps comprises at least one of:
selecting a single stack directly resulting in dumping to calculate the stack similarity score; OR
selecting a plurality of stacks in the dump to calculate the stack similarity score.

4. The method according to claim 3, further comprises:
computing the stack similarity score between the unassigned dump and each of the assigned dumps by comparing lines in the stack from top to bottom line by line.

5. The method according to claim 1, wherein computing a score of other features in each dump in the related assigned dump comprises:
computing a score of each dump in the other features respectively, and computing the score of the other features according to a weight of each dump in the other features.

6. The method according to claim 5, wherein calculating a score of each in the other features respectively comprises:
calculating a recency score of the dump by comparing timestamp information of the dump;
calculating a state score of the dump by determining a current state of the assigned dump;
calculating a release score of the dump by comparing release number information of the dump;
calculating a version score of the dump by comparing version number information of the dump; and
calculating a duplication value score of the dump by determining a number of copies of the assigned dump.

7. The method according to claim 6, wherein calculating at least one of the recency score by comparing the timestamp information, the release score by comparing the release number information or the version score the version number information of the dump comprises:
sorting all the dumps according to at least one of the timestamp information, the release number information or the version number information, and
calculating at least one of the recency score, the release score or the version score according to a sorting interval between the dumps.

8. The method according to claim 6, wherein calculating a state score of the dump by determining a current state of an assigned dump comprises:
calculating the state score of a dump according to an order of the current state of the dump in all the states.

9. The method according to claim 6, wherein calculating the duplication value score of the dump by determining the copy number of the assigned dump comprises:
calculating the duplication value score of a dump according to an accumulated number of copies of a particular assigned dump in all the assigned dumps.

10. The method according to claim 1, wherein assigning the unassigned dump based on the total similarity score comprises:
selecting assignment areas of related assigned dumps having a top K total similarity scores as candidate assignment areas, and
performing statistics on the assignment areas of the related assigned dumps having the top K total similarity scores, and
selecting an assignment area having a highest statistical result as a final assignment area, wherein K≧3.

11. An apparatus of automatic assignment of a dump, the apparatus configured for:
computing a stack similarity score between an unassigned dump and each assigned dumps, and determining all assigned dumps having the stack similarity score greater than a stack similarity score threshold as related assigned dumps;
in response to the determination of the related assigned dumps, computing a score of other features of each dump in the related assigned dumps, the other features comprising at least one of a recency, a state, a release number, a version number and a duplication value associated with the dump;
calculating a total similarity score according to the stack similarity score and the score of the other features; and
assigning the unassigned dump based on the total similarity score.

12. The apparatus according to claim 11, further configured for:
acquiring information related to a stack from the dump, and acquiring information related to the other features from the dump, a system log or a system database.

13. The apparatus according to claim 11, wherein computing a stack similarity score between an unassigned dump and each of the assigned dumps comprises at least one of:
selecting a single stack directly resulting in dumping to calculate the stack similarity score; OR
selecting a plurality of stacks in the dump to calculate the stack similarity score.

14. The method according to claim 13, further configured for:
computing the stack similarity score between the unassigned dump and each of the assigned dumps by comparing lines in the stack from top to bottom line by line.

15. The method according to claim 11, wherein computing a score of other features in each dump in the related assigned dump comprises:
computing a score of each dump in the other features respectively, and computing the score of the other features according to a weight of each dump in the other features.

16. The apparatus according to claim 15, wherein calculating a score of each in the other features respectively comprises:
calculating a recency score of the dump by comparing timestamp information of the dump;
calculating a state score of the dump by determining a current state of the assigned dump;
calculating a release score of the dump by comparing release number information of the dump;
calculating a version score of the dump by comparing version number information of the dump; and
calculating a duplication value score of the dump by determining a number of copies of the assigned dump.

17. The apparatus according to claim 16, wherein calculating at least one of the recency score by comparing the timestamp information, the release score by comparing the release number information or the version score the version number information of the dump comprises:
sorting all the dumps according to at least one of the timestamp information, the release number information or the version number information, and
calculating at least one of the recency score, the release score or the version score according to a sorting interval between the dumps.

18. The apparatus according to claim 16, wherein calculating a state score of the dump by determining a current state of an assigned dump comprises:
calculating the state score of a dump according to an order of the current state of the dump in all the states.

19. The apparatus according to claim 16, wherein calculating the duplication value score of the dump by determining the copy number of the assigned dump comprises:
calculating the duplication value score of a dump according to an accumulated number of copies of a particular assigned dump in all the assigned dumps.

20. A computer program product, comprising a computer readable program instruction embodied therein, when performed by a processor, causing the processor for:
computing a stack similarity score between an unassigned dump and each assigned dumps, and determining all assigned dumps having the stack similarity score greater than a stack similarity score threshold as related assigned dumps;
in response to the determination of the related assigned dumps, computing a score of other features of each dump in the related assigned dumps, the other features comprising at least one of a recency, a state, a release number, a version number and a duplication value associated with the dump;
calculating a total similarity score according to the stack similarity score and the score of the other features; and
assigning the unassigned dump based on the total similarity score.
